(19) United States
(12) Patent Application Publication
(10) Pub. No.: US 2026/0202815 A1
(43) Pub. Date: Jul. 16, 2026

(54) MACHINE TOOL COMMAND GENERATION DEVICE

(71) Applicant: FANUC CORPORATION, Yamanashi (JP)

(72) Inventor: Toshihiro WATANABE, Yamanashi (JP)

(73) Assignee: FANUC CORPORATION, Yamanashi (JP)

(21) Appl. No.: 19/137,623

(22) PCT Filed: Dec. 20, 2022
(86) PCT No.: PCT/JP2022/046926

§ 371 Date: Jun. 10, 2025

(51) Int. Cl. G05B 19/18; G05B 19/19

(52) U.S. Cl. CPC G05B 19/186; G05B 19/19

(57) ABSTRACT

Provided is a technology that, in a machine tool command generation device, makes it possible to improve safety during operation switching and to reduce heat generation or power consumption in a drive part. A machine tool command generation device 1 comprises: a rotational direction acquisition part 11 that acquires the direction of rotational movement; a translation command generation part 12 that generates a command for translational movement per unit time; a sign determination part 13 that determines, on the basis of the direction of the translational movement and the direction of the rotational movement acquired by the rotational direction acquisition part 11, the sign of a synchronization ratio for synchronization; a synchronization ratio determination part 14 that determines an absolute value of the synchronization ratio in accordance with whether the command for the translational movement is a cutting command or a positioning command; and a rotation command generation part 15 that generates a command for the rotational movement on the basis of the command for the translational movement, the sign, and the absolute value. The synchronization ratio between the translational movement and the rotational movement can be changed for the cutting command and the positioning command.

### TECHNICAL FIELD

The present disclosure relates to a command generation device for a machine tool.

### BACKGROUND ART

There is a known technique for a machine tool to machine a workpiece by moving the workpiece while synchronizing two axes, namely, an axis of translational movement and an axis of rotational movement (for example, see Patent Document 1 and Patent Document 2).

### CITATION LIST

### Patent Document

Patent Document 1: Japanese Unexamined Patent Application, Publication No. 2005-216135

Patent Document 2: Japanese Unexamined Patent Application, Publication No. 2015-201968

### DISCLOSURE OF THE INVENTION

### Problems to be Solved by the Invention

In a case where the two axes, namely, the axis of translational movement and the axis of rotational movement are synchronized with each other, a synchronization ratio of the two axes is fixed. In such a configuration, when the synchronization is maintained at switching from cutting operation to positioning operation, high-speed rotation may occur, or operation in an opposite direction may occur. As a method for avoiding such a situation, it is conceivable to cancel the synchronization before the positioning operation. However, this method involves decelerating and stopping the axis of translational movement before the synchronization is canceled, thereby making it necessary to repeat the rotation and stop of the axis of rotational movement each time the cutting operation is performed. To suppress heat generation and power consumption of a driving unit for an axis performing rotational operation, the existing technique has room for improvement.

The present disclosure is made in consideration of the above-described issues, and an object of the present disclosure is to provide, for a command generation device for a machine tool, a technique for improving safety at a time of switching operation and for reducing heat generation and power consumption of a driving unit.

### Means for Solving the Problems

According to the present disclosure, a command generation device for generating commands for a machine tool that performs machining by synchronizing relative translational movement and rotational movement of a tool and a workpiece, includes: a rotation direction acquisition unit configured to acquire a direction of the rotational movement; a translation command generation unit configured to generate a command of the translational movement per unit time; a sign determination unit configured to determine a sign of a synchronization ratio of the synchronizing based on a direction of the translational movement and the direction of the rotational movement acquired by the rotation direction acquisition unit; a synchronization ratio determination unit configured to determine an absolute value of the synchronization ratio according to whether the command of the translational movement is a cutting command or a positioning command; and a rotation command generation unit configured to generate a command of the rotational movement based on the command of the translational movement, the sign, and the absolute value, in which the synchronization ratio of the translational movement and the rotational movement is changeable for the cutting command and the positioning command.

### Effects of the Invention

According to the present disclosure, it is possible to provide, in the command generation device for the machine tool, the technique for improving safety at the time of switching the operation and for reducing heat generation and power consumption of the driving unit.

### BRIEF DESCRIPTION OF THE DRAWINGS

FIG. 1 is a functional block diagram of a numerical control device for a machine tool according to a first embodiment of the present invention;

FIG. 2 is a diagram illustrating an example of a threading program according to the first embodiment;

FIG. 3 is a schematic diagram illustrating positional relationship between a workpiece and a tool when a program command is executed;

FIG. 4 is a flowchart illustrating an example of flow of command generation processing by the numerical control device for the machine tool according to the first embodiment;

FIG. 5 is a schematic diagram illustrating relationship between operation of the tool and a synchronization ratio when the program command is executed;

FIG. 6 is a schematic diagram illustrating the workpiece and moving paths of the tool in threading;

FIG. 7 is a graph illustrating relationship between a Z-axis speed and a C-axis speed in threading according to an existing technique;

FIG. 8 is a functional block diagram of a numerical control device for a machine tool according to a second embodiment of the present invention;

FIG. 9 is a graph illustrating relationship among a Z-axis speed, an X-axis speed, and a C-axis speed before adjustment processing;

FIG. 10 is a graph illustrating the relationship among the Z-axis speed, the X-axis speed, and the C-axis speed after the adjustment processing; and

FIG. 11 is a graph illustrating the relationship among the Z-axis speed, the X-axis speed, and the C-axis speed, and a timing when the adjustment processing is performed at the time of switching operation.

### PREFERRED MODE FOR CARRYING OUT THE INVENTION

Some embodiments of the present disclosure will be described in detail below with reference to drawings. In description of a second and subsequent embodiments, components in common with a first embodiment are denoted by the same reference numerals, and description of the components will be appropriately omitted.

### First Embodiment

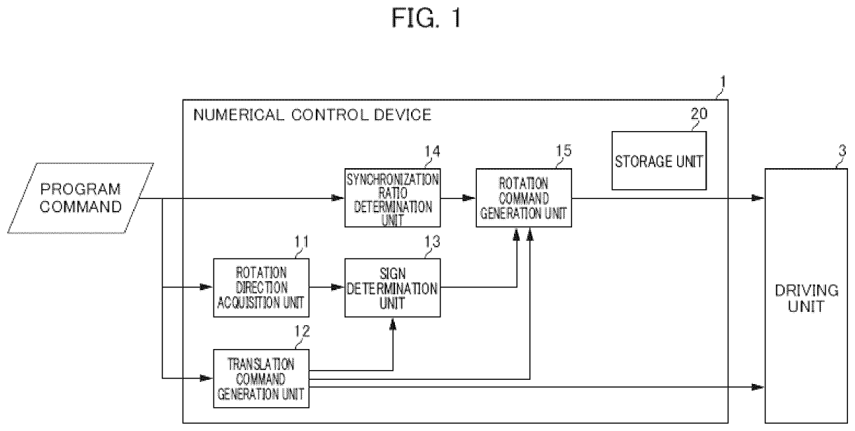

FIG. 1 is a functional block diagram of a numerical control device 1 for a machine tool according to a first embodiment of the present invention. The numerical control device 1 for the machine tool illustrated in FIG. 1 is a command generation device generating commands for the machine tool that performs machining by synchronizing relative translational movement and rotational movement of a tool and a workpiece. The numerical control device 1 according to the present embodiment controls a driving unit 3 based on the generated commands.

The driving unit 3 operates the tool and the workpiece by converting a command of translational movement and a command of rotational movement from the numerical control device 1, into physical translation and rotation. In the following description, for convenience, the driving unit 3 that drives a plurality of feeding axes (Z-axis and X-axis) is described; however, a shape of the workpiece is not limited. Threading according to the present embodiment is applicable to a case where more feeding axes are necessary because the workpiece includes a tapered portion and an arc-shaped portion on a machined surface, and a case where the workpiece has a columnar shape or a cylindrical shape and a feeding axis in one specific axis (Z-axis) is sufficient.

The numerical control device 1 for the machine tool according to the present embodiment is configured using a computer that includes, for example, a memory such as a ROM (read only memory) and a RAM (random access memory) , a CPU (control processing unit), and a communication control unit mutually connected through a bus. Functions and operation of functional units described below are realized when the CPU and the memory mounted on the above-described computer, and control programs stored in the memory cooperate with each other. Further, the numerical control device 1 for the machine tool may include a CNC (Computer Numerical Controller) or a PLC (Programmable Logic Controller) , or may be connected to a host computer that outputs a machining condition such as a rotation speed in addition to machining programs.

As illustrated in FIG. 1, the numerical control device 1 for the machine tool includes a rotation direction acquisition unit 11, a translation command generation unit 12, a sign determination unit 13, a synchronization ratio determination unit 14, a rotation command generation unit 15, and a storage unit 20.

The rotation direction acquisition unit 11 acquires a direction of rotational movement based on a program command. The direction of rotational movement used herein indicates, for example, a rotation direction (positive or negative) of a spindle (C-axis). The program command referenced by the rotation direction acquisition unit 11 may be, for example, a program command stored in the storage unit 20 storing information set by a user, or a program command output from an external computer.

The translation command generation unit 12 generates a command of translational movement (Z-axis and X-axis) per unit time.

The sign determination unit 13 determines a sign of a synchronization ratio based on a direction of the command of the translational movement per unit time and the direction of rotational movement. The sign of the synchronization ratio is positive/negative, and corresponds to a moving direction in an axis direction. In a case where the synchronization ratio is positive, the moving direction in the axis direction is also positive (+direction). In a case where the synchronization ratio is negative, the moving direction in the axis direction is also negative (−direction).

In a case of a cutting command, the synchronization ratio determination unit 14 determines the synchronization ratio for the cutting command. In a case of a positioning command, the synchronization ratio determination unit 14 determines the synchronization ratio for the positioning command. The synchronization ratio may be designated from the program command, or may be previously set in the storage unit 20 of the numerical control device 1.

The rotation command generation unit 15 generates a command of rotational movement (C-axis) per unit time by multiplying the command of the translational movement by the signed synchronization ratio determined by the sign determination unit 13. The rotation command generation unit 15 also generates the command such that a speed of the rotational movement is maintained at the start/end of positioning operation.

The storage unit 20 stores various information for control and machining of the machine tool. In the present embodiment, the storage unit 20 stores the machining condition and the like. The machining condition is, for example, input as a program by an operator, or designated as a parameter of the machine tool. The storage unit 20 may be disposed not inside but outside the numerical control device 1.

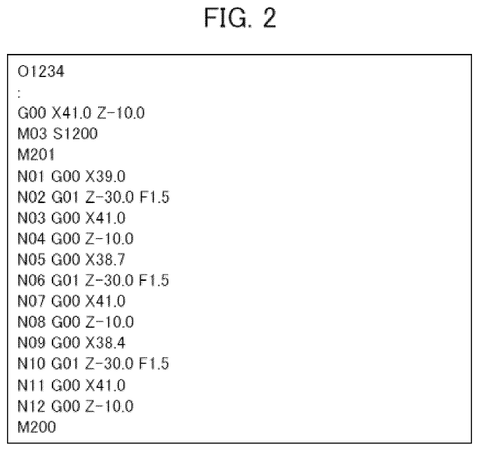

The entire configuration of the numerical control device 1 is described above. Next, a threading program command is described. FIG. 2 is a diagram illustrating an example of a threading program according to the first embodiment. The program illustrated in FIG. 2 is set by, for example, the operator.

In FIG. 2, “X” indicates an X coordinate, and “Z” indicates a Z coordinate.
“G00 X41.0 Z-10.0” is a block for commanding positioning to an initial position.
“M03 S1200” indicates that the spindle performs normal rotation, and “M201” indicates a synchronization-on in which synchronization control is performed. Before a start of threading, synchronization is turned on. In this example, synchronization control between the Z-axis and the C-axis, and synchronization control between the X-axis and the C-axis are both performed. Among them, the Z-axis and the X-axis serve as master axes (axes for translational movement), and the C-axis serves as a slave axis (axis for rotational movement) in any case. In a case where “M04” is described in the program, the rotation direction of the spindle is reverse rotation.

Rows starting from N01 to N12 are commands of positioning movement (positioning operation) and linear movement (cutting operation) in respective stages of threading.
“G00” indicates the positioning operation, “G01” indicates the linear movement in the cutting operation, and “F” indicates a feeding speed.
“M200” indicates a synchronization-off in which the synchronization control is stopped.

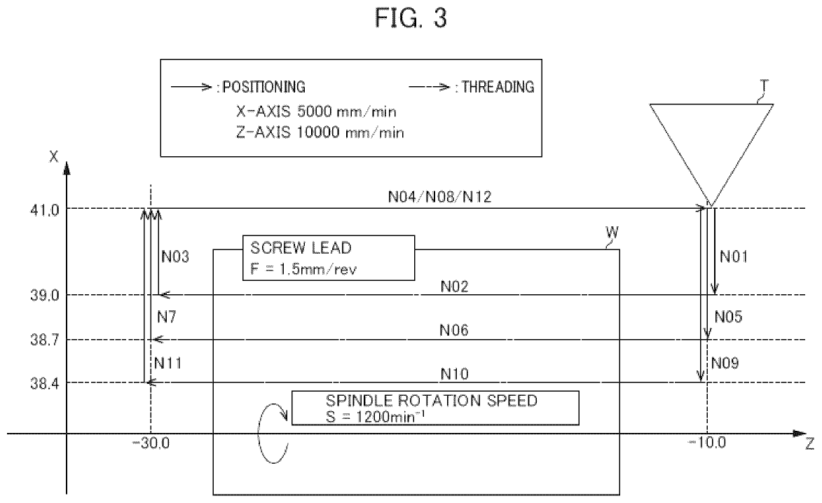

The stages N01 to N12 are described. FIG. 3 is a schematic diagram illustrating positional relationship between a workpiece W and a tool T when the program command is executed in the first embodiment. In a case where the program illustrated in FIG. 2 is executed, commands for performing operation illustrated in FIG. 3 is generated.

FIG. 3 illustrates moving paths of the tool T to the workpiece W in the stages N01 to N12. In FIG. 3, a solid line arrow indicates movement for positioning, and a chain line arrow indicates movement for threading. A threading lead that indicates an advancing distance in the axis direction when a screw rotates once in threading is 1.5 (mm/rev) from the program command. Likewise, a spindle rotation speed S is 1200 (min⁻¹). The feeding speed in machining G01 is calculated based on a product of a screw lead designated by the program and the spindle rotation speed.

As the feeding speed in positioning G00, a value previously stored in the storage unit 20 is used. In this example, it is assumed that, in positioning, the feeding speed of 5000 (mm/min) in the X-axis direction and the feeding speed of 10000 (mm/min) in the Z-axis direction are previously set in the storage unit 20.

In FIG. 3, “N01” indicates movement from the initial position to a machining start position, “N02” indicates linear movement of the cutting tool T from the machining start position in threading (cutting operation), “NO3” indicates movement of the cutting tool T to a retreat position after machining, and “N04” indicates movement from the retreat position to the initial position.
“N01” to “N04” correspond to first machining operation. The initial position of the cutting tool T in the X-axis direction is 41.0, and a cut position in the X-axis direction during the first machining operation is 39.0. Likewise, “N05” to “N08” correspond to second machining operation in which the cut position is set to 38.7, and “N09” to “N12” correspond to third machining operation in which the cut position is set to 38.4.

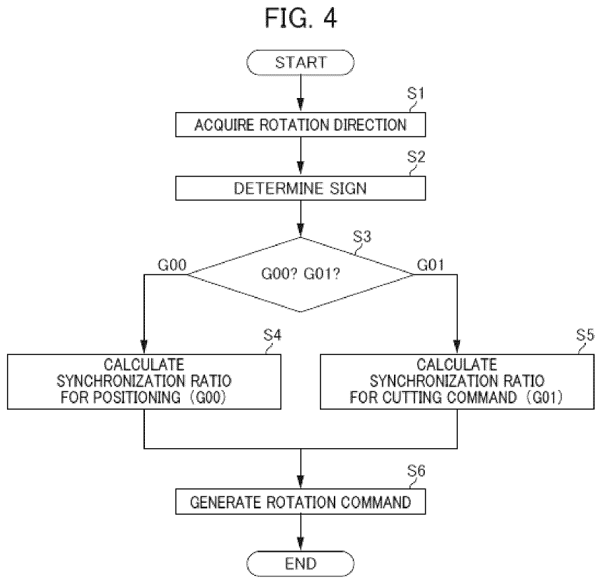

Next, command generation by the numerical control device 1 based on the program command is described. FIG. 4 is a flowchart illustrating an example of flow of command generation processing by the numerical control device 1 for the machine tool according to the first embodiment.

When the numerical control device 1 reads the program command, the rotation direction acquisition unit 11 first acquires the rotation direction (Step S1). For example, as described above, the rotation direction can be acquired by reading “M03” indicating the rotation direction of the spindle in the program illustrated in FIG. 2. In this example, the positive direction of the C-axis serving as the slave axis is acquired as the rotation direction. The method of acquiring the rotation direction is not limited thereto. For example, the rotation direction may be acquired based on feedback information from the spindle at a time point of synchronization-on.

After processing in Step S1, the sign determination unit 13 determines the sign of the synchronization ratio based on the moving direction of translational movement (Z-axis and X-axis) per unit time and the direction of rotational operation (Step S2).

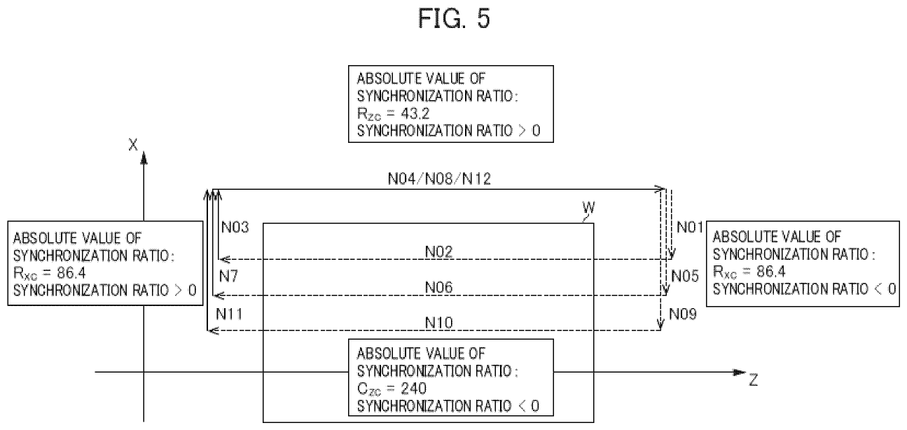

A setting example of the synchronization ratio is described with reference to FIG. 5. FIG. 5 is a schematic diagram illustrating relationship between the operation of the tool T and the synchronization ratio when the program command is executed. In FIG. 5, a dashed line arrow indicates operation in which the synchronization ratio is set to negative by the sign determination unit 13, and a solid line arrow indicates operation in which the synchronization ratio is set to positive by the sign determination unit 13.

In the example illustrated in FIG. 5, the synchronization ratio of each of “N01” and “N02” in the first operation, “N05” and “N06” in the second operation, and “N09” and “N10” in the third operation is set to negative. The synchronization ratio of each of “N03” and “N04” after the machining in the first operation, “N07” and “N08” after the machining in the second operation, and “N11” and “N12” after the machining in the third operation is set to positive.

After the processing in Step S2, the synchronization ratio determination unit 14 determines whether operation in the program command is the positioning operation (G00) or the cutting operation (G01) (Step S3). In a case of the positioning operation (G00), the synchronization ratio determination unit 14 advances the processing to Step S4 (Step S3; G00), In a case of the cutting operation (G01), the synchronization ratio determination unit 14 advances the processing to Step S5 (Step S3; G01).

In Step S4, the synchronization ratio determination unit 14 sets the synchronization ratio for the positioning operation. The synchronization ratio for the positioning operation can be calculated based on (360×spindle rotation speed)/positioning speed. In this example, the feeding speed in the X-axis direction is set to 5000 (mm/min), and the feeding speed in the Z-axis direction is set to 10000 (mm/min). Therefore, the synchronization ratio for the positioning operation is set as follows. Z-C synchronization ratio: R_{ZC}=(360×1200)/10000=43.2 X-C synchronization ratio: R_{XC}=(360×1200)/5000=86.4

In Step S5, the synchronization ratio determination unit sets the synchronization ratio for the cutting command. The synchronization ratio for the cutting command can be calculated based on synchronization ratio=360/feeding speed per rotation (screw pith). In a case of a single-threaded screw, it can be considered that the screw pitch and the screw lead are equal to each other. The threading lead in each operation in cutting is F=1.5. Therefore, the synchronization ratio for the cutting command is set as follows. Z-C synchronization ratio: C_{ZC}=360/F=240 X-C synchronization ratio: C_{XC}=360/F=240

In the example illustrated in FIG. 5, in “N01”, “N05”. and “N09” that are positioning operation from the initial position in the X-axis direction before a start of machining, absolute value R_{XC} of synchronization ratio=86.4, and synchronization ratio<0 are established. In “N02”, “N06”, and “N10” that are linear operation in the Z-axis direction for threading, absolute value C_{ZC} of synchronization ratio 240, and synchronization ratio<0 are established. In “N03” “N07”, and “N11” that are operation to the retreat position in the X-axis direction after machining, absolute value R_{XC} of synchronization ratio=86.4, and synchronization ratio>0 are established. In “N04”, “N08”, and “N12” that are operation from the retreat position to the initial position in the Z-axis direction, absolute value R_{ZC} of synchronization ratio=43.2, and synchronization ratio>0 are established.

After the processing in Step S4 or Step S5 is executed, the rotation command generation unit 15 generates a command of rotational movement (C-axis) per unit time based on the command of the translational movement and the signed synchronization ratio determined by the sign determination unit 13 (Step S6). The rotation command generation unit 15 calculates the command of the rotational movement by, for example, multiplying the command of the translational movement by the signed synchronization ratio determined by the sign determination unit 13. As described above, the rotation command generation unit 15 generates the command such that the speed of the rotational movement is maintained at the start/end of the positioning operation.

As described above, the series of processing is performed in each of the blocks between the synchronization-on and the synchronization-off of the program, thereby generating the movement commands of the entire machining. Among the movement commands of the entire machining, the movement command of the translational movement is generated based on the program. The numerical control device 1 performs driving control of the driving unit 3 based on the generated movement commands. Note that the flowchart is merely illustrative, and the processing order and the processing contents can be appropriately changed.

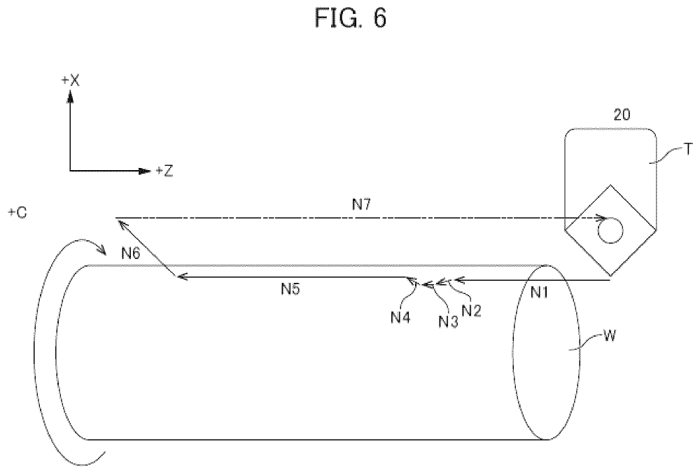

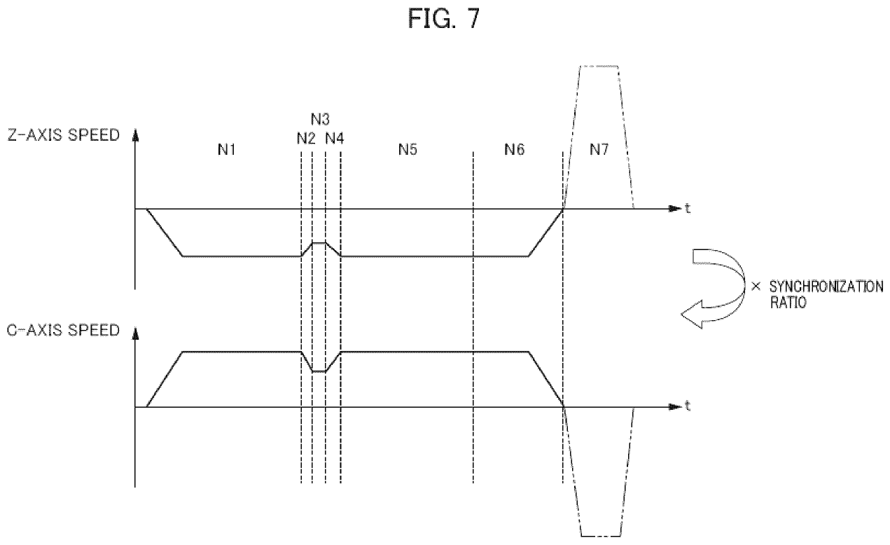

Next, effects by the present embodiment relative to the existing technique are described with reference to FIG. 6 and FIG. 7. FIG. 6 is a schematic diagram illustrating the workpiece W and moving paths of the tool W in threading. FIG. 7 is a graph illustrating relationship between a Z-axis speed and a C-axis speed in threading as the existing technique. In FIG. 6 and FIG. 7, the moving paths of the tool T corresponding to respective sequence numbers N1 to N7 are illustrated. Among them, parts of the sequence numbers N1 to N6 illustrated by solid lines correspond to the moving paths in machining, and a part of the sequence number N7 illustrated by a chain line corresponds to movement from the retreat position to the initial position.

Even in the existing technique, the movement command in a synchronization slave axis (axis for rotational movement) is generated by multiplying a movement command of a master axis (axis for translational movement) by a predetermined ratio. In threading, the master axis is set to the Z-axis, and the slave axis is set to the C-axis. Thus, the spindle is rotated in a manner corresponding to the operation in the Z-axis. Even if the speed in the Z-axis is varied due to some causes as with the moving paths corresponding to the sequence numbers N2 to N4, the synchronization control enables machining without losing synchronization. Examples of some causes include change of override, and occurrence of an even in which analysis processing of minute segments is too late.

However, when the tool T is caused to perform the cutting operation and the positioning operation in this order while the synchronization is maintained, high-speed operation in the C-axis or operation in an opposite direction may occur, which is dangerous (for example, N7). On the other hand, in a case where the synchronization is canceled before the positioning, it is necessary to stop operation the Z-axis and the X-axis before canceling the synchronization. As a result, rotation and stop in the C-axis are repeated every time the cutting operation is performed, which increases heat generation and power consumption of the driving unit for the C-axis.

In this respect, the numerical control device 1 for the machine tool according to the first embodiment described above achieves the following effects.

The numerical control device 1 for the machine tool includes the rotation direction acquisition unit 11 acquiring the direction of the rotational movement, the translation command generation unit 12 generating the command of the translational movement per unit time, the sign determination unit 13 determining the sign of the synchronization ratio of the synchronization based on the direction of the translational movement and the direction of the rotational movement acquired by the rotation direction acquisition unit 11, the synchronization ratio determination unit 14 determining the absolute value of the synchronization ratio according to whether the command of the translational movement is a cutting command or a positioning command, and the rotation command generation unit 15 generating the command of the rotational movement based on the command of the translational movement, the sign, and the absolute value. The synchronization ratio of the translational movement and the rotational movement can be changed for the cutting command and the positioning command. As a result, it is possible to avoid occurrence of high-speed rotation in the C-axis and rotation in an opposite direction during the positioning operation, and to improve safety. Further, it is possible to lengthen the time when the speed in the C-axis is constant, and to reduce heat generation and power consumption of the driving unit 3.

Further, the rotation command generation unit 15 according to the present embodiment generates the command of the rotational movement such that the speed of the rotational movement is maintained at the start and the end of the positioning operation. As a result, a rate of the time when the constant speed in the C-axis is maintained can be increased, which makes it possible to further suppress heat generation and power consumption of the driving unit 3. In addition, even in a case where a plurality of cutting commands are continued, the speed of the rotational movement is limited at the start and the end of the positioning operation. This makes it possible to avoid occurrence of a defective screw caused by maintenance of the speed of the rotational movement.

In the present embodiment, the machining in which the translational movement and the rotational movement are synchronized is threading. In threading in which the cutting operation and the positioning operation are repeated, the configuration in which the synchronization ratio is not fixed according to the present embodiment is particularly suitable.

The numerical control device 1 for the machine tool according to the first embodiment is described above; however, the configuration is not limited to the configuration according to the above-described embodiment. In the following, an embodiment different from the above-described embodiment is described.

### Second Embodiment

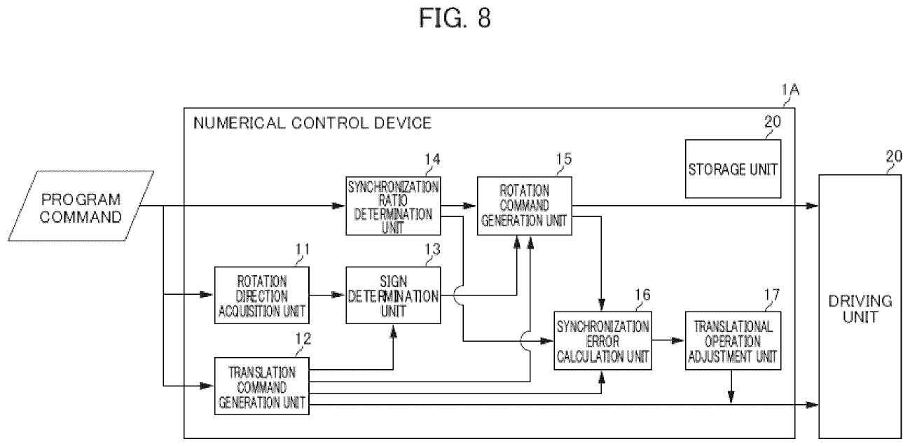

Next, a numerical control device 1A according to a second embodiment is described. FIG. 8 is a functional block diagram of the numerical control device for the machine tool according to the second embodiment of the present invention. The numerical control device 1A according to the second embodiment is different from the numerical control device 1 according to the above-described embodiment in that the numerical control device 1A further includes a synchronization error calculation unit 16 and a translational operation adjustment unit 17. The other configurations are in common.

The synchronization error calculation unit 16 calculates a synchronization error between the translational movement and the rotational movement at the start and the end of the translational movement. The synchronization error with the translational movement as a reference can be determined in the following manner by using the synchronization ratio. The synchronization ratio used at this time is a value set by the synchronization ratio determination unit 14. Synchronization error=command of rotational movement/synchronization ratio−command of translational movement

The translational operation adjustment unit 17 performs adjustment processing for adjusting a start timing of the translational operation based on the synchronization error calculated by the synchronization error calculation unit 16. In the adjustment processing, the translational operation adjustment unit 17 performs calculation such that a cumulative value of the synchronization error becomes equal to a value obtained by adding a predetermined constant to an integral multiple of one rotation of the rotational movement. For example, in a case of an N-threaded screw, the translational operation adjustment unit 17 performs calculation such that integral multiple of one rotation+360 degrees/N becomes equal to the cumulative value of the synchronization error. In a case of a double-threaded screw, the predetermined constant is 180 degrees. The predetermined constant is determined to be 540 degrees, 900 degrees, and the like.

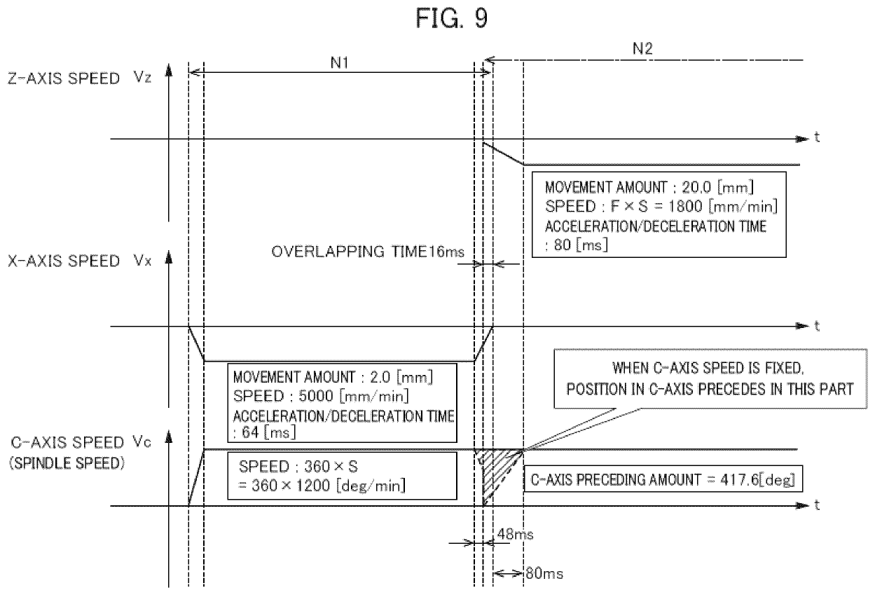

The adjustment processing by the synchronization error calculation unit 16 and the translational operation adjustment unit 17 according to the second embodiment is described. FIG. 9 is a graph illustrating relationship among the Z-axis speed (Vz), the X-axis speed (Vx), and the C-axis speed (Vc) before the adjustment processing.

As illustrated in FIG. 9, in a case where the movement command of the rotational operation (C-axis) per unit time is calculated, while the translational operation is accelerated and decelerated, the C-axis is also accelerated and decelerated. To suppress heat generation, the C-axis speed that is the spindle is preferably constant. In a case where the C-axis speed is constant, however, synchronization shift occurs between the translational operation and the rotational operation. In other words, when the C-axis speed is fixed, a phenomenon in which a position in the C-axis precedes occurs.

Therefore, in the second embodiment, the adjustment processing is performed after the rotation command generation unit 15 generates the movement command such that the C-axis speed is made constant during acceleration/deceleration in the X-axis and the Z-axis. First, the synchronization error calculation unit 16 calculates a preceding amount in the C-axis based on a time constant during acceleration or deceleration in the X-axis and the Z-axis, and an overlapping time of the blocks. £ In FIG. 9, the preceding amount is calculated as an area based on the acceleration/deceleration time and the overlapping time.

In a case of the operation in the X-axis in Nl of FIG. 9, a movement amount is 2.0 (mm), the speed is 5000 (mm/min), and the acceleration/deceleration time is 64 (ms). In a case of the operation in the Z-axis in N2, the movement amount is 20.0 (mm), the speed F×S=1800 (mm/min), and the acceleration/deceleration time is 80 (ms). In a case of the operation in the C-axis as the spindle, the speed is 360×S=360×1200 (deg/min). In the example illustrated in FIG. 9. the overlapping time is 16 ms. Therefore, the synchronization error calculation unit 16 calculates the C-axis preceding amount as 417.6 (deg).

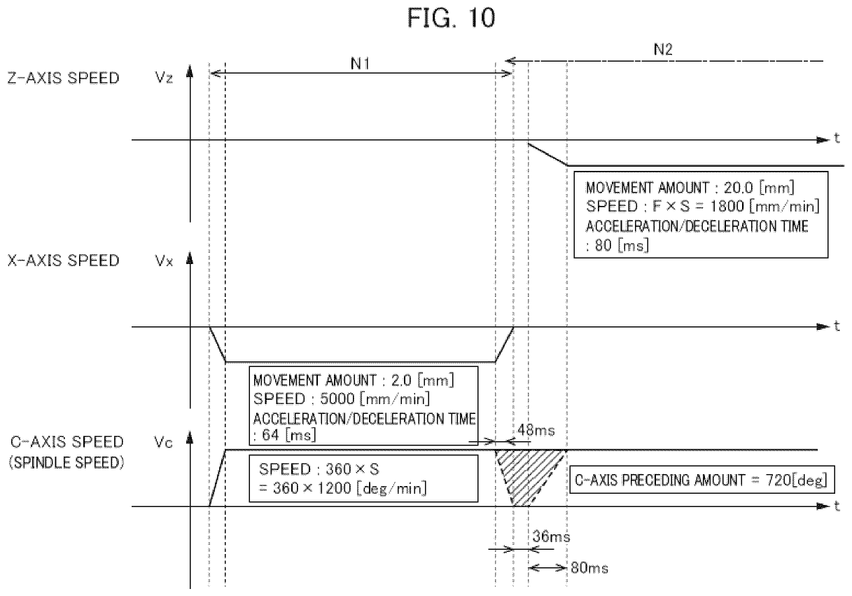

Thereafter, the translational operation adjustment unit 17 performs the adjustment processing for delaying a start of the cutting block such that the C-axis preceding amount calculated by the synchronization error calculation unit 16 becomes equal to an integral multiple of 360 degrees. FIG. 10 is a graph illustrating the relationship among the Z-axis speed, the X-axis speed, and the C-axis speed after the adjustment processing. In an example illustrated in FIG. 10, the translational operation adjustment unit 17 performs the adjustment processing for delaying a start of N2 indicating the cutting command by 36 (ms) such that the C-axis preceding amount becomes 720 (deg) as the integral multiple of 360 degrees.

In the second embodiment, in terms of reduction of a non-cutting time, the synchronization error calculation unit 16 calculates the synchronization error in a block from the cutting operation to the positioning operation and in a block from the positioning operation to another positioning operation, but the adjustment processing is performed so as not to delay a start of the block. In other words, in a case where the start timing of the translational movement is adjusted, the translational movement is limited only to the cutting command immediately after the positioning command.

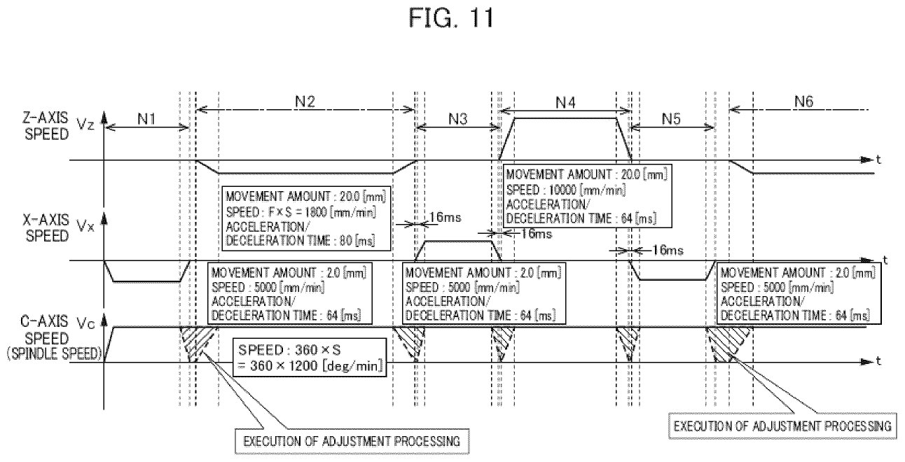

FIG. 11 is a graph illustrating the relationship among the Z-axis speed, the X-axis speed, and the C-axis speed, and a timing when the adjustment processing is performed at the time of switching operation. In an example illustrated in FIG. 11, the adjustment processing for delaying the start timing of the cutting operation is performed only at switching from the positioning operation to the cutting operation, namely, from N1 to N2, and at switching from the positioning operation to the cutting operation, namely, from N5 to N6. In other words, the adjustment processing is performed such that the C-axis preceding amount (area) at switching from N1 to N2 becomes equal to an integral multiple of 360 degrees.

The adjustment processing from N5 to N6 is performed based on a synchronization error at switching from N2 to N3 that is switching from the cutting operation to the positioning operation, a synchronization error at switching from N3 to N4 and switching from N4 to N5 that are switching from the positioning operation to another positioning operation, and a synchronization error at switching from N5 to N6 that is switching from the positioning operation to the cutting operation of N1 to N2. In other words, the adjustment processing is performed such that a total value (total area) of the preceding amount (area) at switching from N2 to N3, the preceding amount (area) at switching from N3 to N4, the preceding amount (area) at switching from N4 to N5, and the preceding amount (area) at switching from N5 to N6 becomes equal to an integral multiple of 360 degrees. In this example, at switching from N2 to N5, the adjustment processing for delaying the start timing of next operation is not performed, and only the synchronization error is calculated.

The numerical control device 1 for the machine tool according to the second embodiment described above achieves the following effects. The numerical control device 1 further includes, in addition to the rotation direction acquisition unit 11, the translation command generation unit 12, the sign determination unit 13, the synchronization ratio determination unit 14, and the rotation command generation unit 15, the synchronization error calculation unit 16 calculating the synchronization error between the translational movement and the rotational movement at the start and the end of the positioning operation, and the translational operation adjustment unit 17 adjusting the start timing of the translational movement such that the cumulative value of the calculated synchronization error becomes equal to a value obtained by adding a predetermined constant to an integral multiple of one rotation of the rotational movement. As a result, it is possible to avoid synchronization shift between the translational operation and the rotational operation that may occur in the case where the C-axis speed is constant, and to realize more stable machining operation.

In the present embodiment, the translational operation adjustment unit 17 adjusts the start timing of only the translational movement of the cutting command immediately after the positioning command. Therefore, the adjustment processing is performed on the phase in the C-axis at the start of machining large in influence to realize stable machining operation, whereas the adjustment processing is not performed at switching to the other operation less in necessity for stabling the phase. Therefore, as compared with a case where all the start timings are delayed, it is possible to shorten the non-cutting time, and to effectively suppress increase of a cycle time.

As described above, in the second embodiment, the example in which the adjustment processing is performed only in the case where the operation is switched from the positioning operation to the cutting operation is described; however, the adjustment processing may be applied to all of the operation switching time, namely, the time when the operation is switched from the cutting operation to the positioning operation, the time when the operation is switched from the positioning operation to another positioning operation, and the time when the operation is switched from the positioning operation to the cutting operation.

Further, in the above-described embodiments, the example of threading is described; however, the configuration is not limited thereto. For example, the numerical control device 1 according to the present embodiment can be applied to a machine tool performing gear machining.

Further, in the above-described embodiments, as the examples of the command generation apparatus, the numerical control devices 1 and 1A controlling the driving unit 3 are described; however, the configuration is not limited thereto. For example, the present invention can be applied to a computer generating only commands.

Although the present disclosure is described in detail, the present disclosure is not limited to the above-described individual embodiments. These embodiments can be variously added, replaced, changed, partially deleted, and the like without departing from the gist of the present disclosure or without departing from the spirit of the present disclosure derived from the contents of the claims and equivalents thereof. Further, these embodiments cam be implemented in combination. For example, in the above-described embodiments, the order of the operation and the order of the processing are illustrative and are not limited thereto. This is true when numerical values or expressions are used in the above description of the embodiments

The following further discloses additional remarks regarding the foregoing embodiments and modifications thereof.

### (Additional Remark 1)

A command generation device (1, 1A) for generating commands for a machine tool that performs machining by synchronizing relative translational movement and rotational movement of a tool (T) and a workpiece (W), the command generation device including:
a rotation direction acquisition unit (11) configured to acquire a direction of the rotational movement;
a translation command generation unit (12) configured to generate a command of the translational movement per unit time;
a sign determination unit (13) configured to determine a sign of a synchronization ratio of the synchronizing based on a direction of the translational movement and the direction of the rotational movement acquired by the rotation direction acquisition unit;
a synchronization ratio determination unit (14) configured to determine an absolute value of the synchronization ratio according to whether the command of the translational movement is a cutting command or a positioning command; and
a rotation command generation unit (15) configured to generate a command of the rotational movement based on the command of the translational movement, the sign, and the absolute value, in which the synchronization ratio of the translational movement and the rotational movement is changeable for the cutting command and the positioning command.

### (Additional Remark 2)

In the command generation device (1, 1A) for the machine tool described above,
the rotation command generation unit (15) generates the command of the rotational movement such that a speed of the rotational movement is maintained at a start and an end of positioning operation.

### (Additional Remark 3)

The command generation device (1A) for the machine tool described above, further including:
a synchronization error calculation unit (16) configured to calculate a synchronization error between the translational movement and the rotational movement at the start and the end of the positioning operation; and
a translational operation adjustment unit (17) configured to adjust a start timing of the translational movement such that a cumulative value of the synchronization error calculated becomes equal to a value obtained by adding a predetermined constant to an integral multiple of one rotation of the rotational movement.

### (Additional Remark 4)

In the command generation device (1A) for the machine tool described above,
the translational operation adjustment unit (17) adjusts the start timing of only the translational movement of the cutting command immediately after the positioning command.

### (Additional Remark 5)

In the command generation device (1, 1A) for the machine tool described above,
machining in which the translational movement and the rotational movement are synchronized is threading.

### EXPLANATION OF REFERENCE NUMERALS

1, 1A: Numerical control device for machine tool
11: Rotation direction acquisition unit
12: Translation command generation unit
13: Sign determination unit
14: Synchronization ratio determination unit
15: Rotation command generation unit
16: Synchronization error calculation unit
17; Translational operation adjustment unit

1. A command generation device for generating commands for a machine tool that performs machining by synchronizing relative translational movement and rotational movement of a tool and a workpiece, the command generation device comprising:
a rotation direction acquisition unit configured to acquire a direction of the rotational movement;
a translation command generation unit configured to generate a command of the translational movement per unit time;
a sign determination unit configured to determine a sign of a synchronization ratio of the synchronizing based on a direction of the translational movement and the direction of the rotational movement acquired by the rotation direction acquisition unit;
a synchronization ratio determination unit configured to determine an absolute value of the synchronization ratio according to whether the command of the translational movement is a cutting command or a positioning command; and
a rotation command generation unit configured to generate a command of the rotational movement based on the command of the translational movement, the sign, and the absolute value,
wherein the synchronization ratio of the translational movement and the rotational movement is changeable for the cutting command and the positioning command.

2. The command generation device for the machine tool according to claim 1, wherein
the rotation command generation unit generates the command of the rotational movement such that a speed of the rotational movement is maintained at a start and an end of positioning operation.

3. The command generation device for the machine tool according to claim 2, further comprising:
a synchronization error calculation unit configured to calculate a synchronization error between the translational movement and the rotational movement at the start and the end of the positioning operation; and
a translational operation adjustment unit configured to adjust a start timing of the translational movement such that a cumulative value of the synchronization error calculated becomes equal to a value obtained by adding a predetermined constant to an integral multiple of one rotation of the rotational movement.

4. The command generation device for the machine tool according to claim 3, wherein
the translational operation adjustment unit adjusts the start timing of only the translational movement of the cutting command immediately after the positioning command.

5. The command generation device for the machine tool according to claim 1, wherein
machining in which the translational movement and the rotational movement are synchronized is threading.

6. The command generation device for the machine tool according to claim 2, wherein
machining in which the translational movement and the rotational movement are synchronized is threading.

7. The command generation device for the machine tool according to claim 3, wherein
machining in which the translational movement and the rotational movement are synchronized is threading.

8. The command generation device for the machine tool according to claim 4, wherein
machining in which the translational movement and the rotational movement are synchronized is threading.
